(19) United States
(12) Patent Application Publication
(10) Pub. No.: US 2020/0375167 A1
(43) Pub. Date: Dec. 3, 2020

(54) Ice Fishing Bite Indicator Alert Device

(71) Applicants: Jeff West, Wayzata, MN (US); John Matthew LaHood, Waconia, MN (US)

(72) Inventors: Jeff West, Wayzata, MN (US); John Matthew LaHood, Waconia, MN (US)

(21) Appl. No.: 16/424,134

(22) Filed: May 28, 2019

(51) Int. Cl. A01K 97/12; A01K 97/01; A01K 87/00

(52) U.S. Cl. CPC A01K 97/125; A01K 85/01; A01K 87/007; A01K 97/01

(57) ABSTRACT

An ice fishing bite indicator alert device for use with a reel having wound fishing line with the device including a housing to be mounted proximate the fishing reel and a movement indicator actuator located on the reel in a position spaced from an axis of rotation of the reel. The housing supports an electrically connected circuit that includes a trigger switch, at least one light source, at least one power source, and an on/off switch, with the trigger switch located within a path of movement of the movement indicator actuator. The electrically connected circuit has an inactivated state and an activated state which are associated with the location of the movement indicator actuator relative to the trigger switch and which control whether the trigger switch enables the power source to provide power to the light. The device also may include a sound source to provide an audible alert.

### CROSS-REFERENCE TO RELATED APPLICATION

This application claims the benefit of priority of U.S. Provisional Patent Application Ser. No. 62/677,446, filed May 29, 2018, the disclosure of which is hereby incorporated by reference in its entirety.

### BACKGROUND OF THE INVENTION

### Field of the Invention

The present invention generally relates to accessories used in ice fishing, and more particularly to apparatus for alerting a fisherman of a fish bite or hooked fish.

### Background

Ice fishing (winter fishing through the surface ice on a lake) typically involves holding a fishing line still while waiting for a fish to bite. To assist in this task, a fisherman can use a reel that is supported above the ice, or otherwise statically supported. One challenge, particularly when fishing at night, is to alert a fisherman when a fish is tugging on the line that is statically supported, rather than hand-held.

This problem has been address, in part, by using a rattle reel device. A rattle reel device emits an audible noise when a fishing line that is wound on a reel is tugged or “activated” by a fish bite. Conventional rattle reels include a fishing reel with a bell or other noise-making item that typically is contained within the reel. A fishing line is wound around the reel and the free end of the line (with the hook, bait, lure, etc.) is lowered into the water. When a fish tugs on the line, the line unwinds off of the reel, causing the reel to rotate and the bell or other noise-making item to rattle or jingle. This alerts the fisherman that a fish is interested in, or has taken the bait.

Fishing at night, or once the sun has set, includes the need for an artificial light source, such as a lantern, headlamp, flashlight, etc., to permit a fisherman to see his or her equipment, surroundings, etc., which may include the fishing reel, tackle box, food, beverages and the furnishings inside a shelter or fish house. Fishermen often deploy multiple fishing lines, and therefore, may seek to monitor multiple fishing lines on multiple corresponding reels or rattle reels. Depending on the extent of the darkness, it may be difficult to see which reel has been activated. As the sun sets very early during the ice fishing season, this difficulty in monitoring fishing lines is quite common.

Of course, fishing at night may include the added challenge of being woken up from sleep in order to attend to a biting fish. Depending on the fisherman, his or her level of fatigue, and the type of rattle reel in use, the audible noise created by the rattle reel may be sufficient to accomplish the task of waking the fisherman. However, while the noise created by a typical rattle reel may be sufficient to wake a fisherman, a noise alone is not completely effective at night, dusk or very early in the morning in low natural ambient light, because a fisherman may have multiple fishing lines in the water at the same time, or more than one fisherman may be using the same shelter or fish house and may have multiple lines in the water. This may present a very challenging environment for determining which of the potentially multiple reels is being activated by a fish bite or a fish being hooked and pulling on the fishing line. This problem may be accentuated by the additional complication of waking from a sleeping state, having to regain one's bearings and to try to quickly determine which line requires attention.

### SUMMARY

In order to facilitate the identification of an activated reel or rattle reel in low light conditions, the present disclosure provides a particularly advantageous ice fishing bite indicator alert device that emits light and/or sound to direct a fisherman's attention to the correct fishing line. The device, which may, in part, include a rattle reel, also advantageously turns on at least one artificial light source that is of adequate brightness, so that the fisherman can see the fishing gear necessary to efficiently attend to the appropriate fishing line and reel. The device also may turn on a sound source, which would help to determine which reel, potentially among a plurality of reels, is requiring attention.

Thus, the addition of a bite indicator alert device that emits light and/or sound when a reel is activated (at least partially rotated due to a fish bite or a fish being hooked, which tugs on the fishing line) may greatly assist a fisherman by facilitating identification of an activated reel, and the illumination of the immediate surroundings, to permit the fisherman to take care of the proper line. This is particularly advantageous as compared to turning on a separate flashlight and then checking each line individually.

An ice fishing bite indicator alert device in accordance with the present disclosure may include a combination of some of the following components that may be assembled as described herein. Such a device may include the illustrated embodiments of a bite indicator alert device, which may be fitted to a reel assembly that may include a rattle reel or other reel device, in order to enable an activated reel to provide an alert. The device may include a housing to enclose other components, which may include a removable cover. An on/off switch may be provided to turn the alert device “on” and “off”. A power source may be used and may include one or more batteries, which may be of various types, such as alkaline, lithium, etc., and which may be rechargeable. An AC to DC converter may be used, or a combination of both one or more batteries and an AC to DC converter. The device may include at least one light source, which may be at least one Light Emitting Diode (LED), or at least one incandescent bulb, or a combination of at least one LED and at least one incandescent bulb, or other light sources, such as for example, gas discharge lamps. The device also or alternatively may include one sound source, such as a horn or a sound chip module.

The bite indicator alert device may further include a mount for connecting the device to a reel assembly or other suitable support. A trigger switch or sensor may be included, which may be, for example, a non-contact proximity switch/sensor, or a contact switch/sensor. A non-contact proximity switch may include, for example, magnetically actuated switches and sensors, for example, reed switches and reed sensors, solid state magnetic switches, inductive sensors, or latching (or bi-stable) reed switches and sensors. Other non-contact sensors may include Hall effect, photoelectric and capacitive switches or sensors, and still other non-contact sensors also are contemplated. Contact switches may include, for example, a micro switch with a hinge lever, a micro switch with a roller lever or a wide contact angle positioning switch that is configured to detect sliding and/or rotating objects.

The ice fishing bite indicator alert device may include one or more movement indicator actuator(s), which may be one or more magnets or pieces of metal configured as a protruding feature, such as a boss or a bump, a boss or bump with filleted interior and/or exterior edges, or a linear bump which can generally be in the shape of a speed bump, or alternatively a recessed feature which may be shaped similarly to any of the protruding features, but inverted, so as to form the shape as a recessed feature.

A cover for the housing may be provided. The cover may help to conceal and protect wiring and possibly additional electrical components, such as one or more optional resistor(s), the use of which may depend on, inter alia, the combination of the power source and light source that are selected. One or more resistors of appropriate ohms may be needed to appropriately limit the current flow in the circuit. Similarly, one or more optional transistor(s) may be included, and their use depends on, inter alia, the combination of the triggered switch and light source that are selected. Also, one or more appropriately rated transistors may be needed to control the current flow in the circuit.

As one skilled in the art will recognize, in addition to the above-identified components and their alternatives, additional or similar suitable components may be used. Some of these substitutes may be beneficial because they may provide a more economically viable and/or a more efficient power-consuming alert device. Some may be beneficial as they may help create a more durable or reliable device. In addition, newly developed components may, in some cases, combine the functions of multiple existing components and/or improve performance over those that are described herein. Such substitutions and/or additions that permit any of the described circuit embodiments to perform its intended operation are fully within the scope of this patent application disclosure. From this disclosure, it will be appreciated that there are many possible embodiments of the innovations that are disclosed. It will be understood that a particular feature or features from one example embodiment may be combined with a particular feature or features of another example embodiment, even if they are not described together or are not depicted in the same figure, and therefore, they remain within the scope of this disclosure. Thus, many possible embodiments may be made without departing from the teaching of the disclosure. It also is to be understood that all embodiments that are described in the text and/or in the drawings are illustrative and do not limit the scope of what has been disclosed.

### BRIEF DESCRIPTION OF THE DRAWINGS

In describing the preferred embodiments, reference is made to the accompanying drawing figures wherein like parts have like reference numerals, and wherein:

FIG. 1 is a perspective view of an example ice fishing bite indicator alert device mounted to a reel assembly.

FIG. 2 is a side view of the device illustrated in FIG. 1, in an inactivated state, with a movement indicator actuator in close proximity to a trigger switch.

FIG. 3 is a side view of the device illustrated in FIGS. 1 and 2, but now in an activated state, after the fishing line has been partially unwound from the reel, such that the movement indicator actuator is no longer in close proximity to a trigger switch.

FIG. 4 is a top view of the device illustrated in FIGS. 1-3, but removed from the reel assembly and indicating a cross-section line.

FIG. 5 is a side cross-sectional view in accordance with the cross-section line indicated in FIG. 4.

FIG. 6 is a first example simplified circuit diagram for the alert device illustrated in FIGS. 1-5 and in the inactivated state, corresponding to FIG. 2.

FIG. 7 is further view of the first example simplified circuit diagram shown in FIG. 6, but in the activated state, corresponding to FIG. 3.

FIG. 8 is a second example simplified circuit diagram for an alert device similar to that which is illustrated in FIGS. 1-5, and in an inactivated state.

FIG. 9 is a third example simplified circuit diagram for an alert device similar to that which is illustrated in FIGS. 1-5, and in an inactivated state.

FIG. 10 is a fourth example simplified circuit diagram for an alert device similar to that which is illustrated in FIGS. 1-5, and in an inactivated state.

FIG. 11 is a fifth example simplified circuit diagram for an alert device similar to that which is illustrated in FIGS. 1-5, and in an inactivated state.

FIG. 12 is a sixth example simplified circuit diagram for an alert device similar to that which is illustrated in FIGS. 1-5 but using a contact switch, and in an activated state.

FIG. 13 is a seventh example simplified circuit diagram for an alert device similar to that which is illustrated in FIGS. 1-5, with the addition of a sound source and in an inactivated state.

It should be understood that the figures are not to scale. While some mechanical details of example ice fishing bite indicator, including additional plan and section views of the example shown and of examples that may have alternative configurations have not been included, such details are considered well within the comprehension of those of skill in the art in light of the present disclosure. It also should be understood that the present invention is not limited to the example embodiment illustrated.

### DETAILED DESCRIPTION OF THE PREFERRED EMBODIMENTS

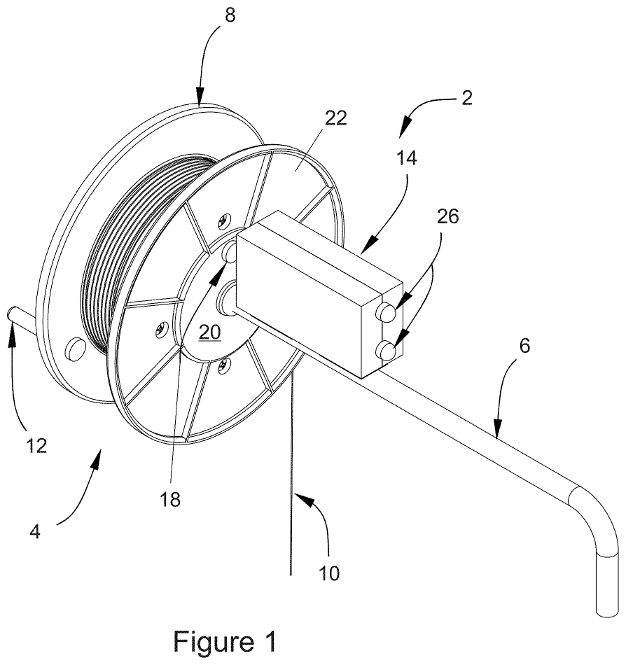

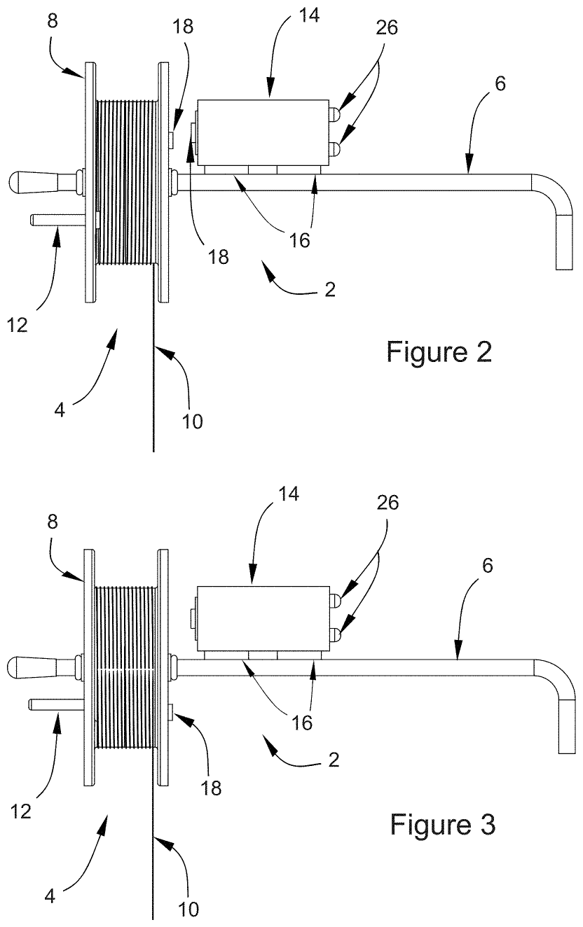

The Figures that follow illustrate various aspects of example ice fishing bite indicator alert devices that are constructed in accordance with the present disclosure. FIGS. 1-3 show an example ice fishing bite indicator alert device 2 that is connected to a reel assembly 4 that may be used for ice fishing. The reel assembly 4 includes an axle 6 on which a reel 8 is rotatable. The axle 6 may be supported by any known means of holding the axle 6 in a steady position above a hole through ice. For instance, the axle 8 may be mounted to another structure, such as a separate support device, which may include a wall of a fish house, or a support that is resting or supported on the floor or on the ice, such as a tri-pod or the like.

The reel 8 has fishing line 10 wound around the reel and extending downward, and a handle 12 to permit a user to wind the fishing line 10 around the reel 8. While not shown, for convenience, the distal end of the downward extending fishing line 10 would include a lure, hook or other suitable device, and may include bait connected to such device for attracting and hooking a fish.

The bite indicator alert device 2 is connected to and works in conjunction with the reel assembly 4. The housing 14 has a mount 16 that locates the housing proximate the reel 8. For example, the device 2 includes a housing 14 that is connected to the axle 6, and the connection may be accomplished by use of mount 16. In this instance, the mount includes two magnets that are affixed to the housing 14 and that magnetically connect to the axle 8 of the reel assembly 4, thereby locating the housing proximate the reel 8. Of course, any other type of suitable mount may be used, for example, one or more screw-type clamps, spring or circular clamps, adjustable nylon straps, which can be fastened by hook and loop (Velcro) closures, adjustable and/or elasticized straps, suction cups or adhesive. Also, the housing need not be mounted to the axle of the reel, as it may be mounted to a different structure. As one skilled in the art will appreciate, the mount 16 securely holds the housing 14 in place relative to a reel assembly 4 and accordingly, compatibility with the reel's mounting/support hardware may be an important factor in selection of the mount.

The device 2 also includes at least one movement indicator actuator 18 located on the reel 8 in a position spaced from an axis of rotation of the reel 8 on the axle 6. In this example, the indicator actuator is connected to an outer surface 20 the reel 8, such as on the side wall 22 of the reel 8. The movement indicator actuator 18 may be connected to the reel by adhesive, by a mechanical fastener or holder or by other suitable means of connection that will expose an outer face of the indicator actuator 18 to the housing 14. The indicator actuator 18 may be of alternative constructions with different shapes, sizes and materials, such as being a magnet or piece of metal, such as a plain carbon steel pellet or other suitable piece, as described further herein and so as to correspond to other operative components of the device 2. The magnets or metal pieces may be of disk or other shapes, for example, they may be an rectangular, pie-shaped or in other configurations. A sheet magnet may be used, for example, in a configuration of an elongated strip or generally circular shape but with a portion missing, such as slice of a pie, with a missing slice corresponding to a gap. Depending on the magnetic strength of the magnets used and the desired pattern of their influence on the trigger switch, one or more magnets may be used and located adjacent each other or spaced apart accordingly.

The reel assembly 4 also may be of a “rattle reel” construction, wherein the reel 8 includes a noise making apparatus, such as is known in the art and is contained within the center of the reel 8. Alternatively, the reel may not include any provision for generating sound upon rotation.

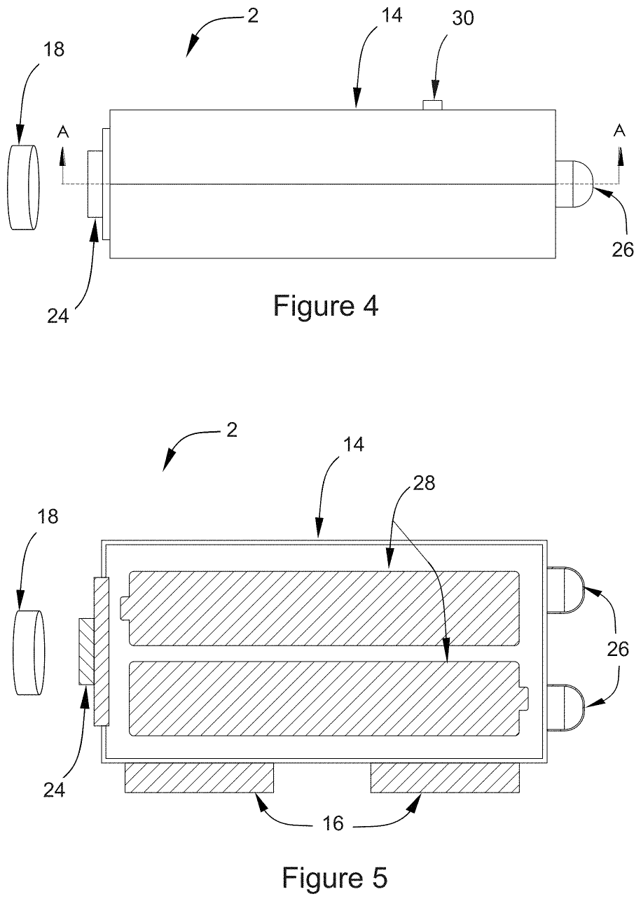

A simplified diagram of a first example bite indicator alert device 2 is shown in FIGS. 4 and 5. For example, the housing 14 of the device 2 is shown in this example as supporting a trigger switch 24, which may be a switch or sensor having “open” and “closed” positions, at least one light source 26, such as a light emitting diode (LED), which in this example includes two LEDs, at least one power source 28, which in this example includes two batteries that optionally may be rechargeable, and an on/off switch 30.

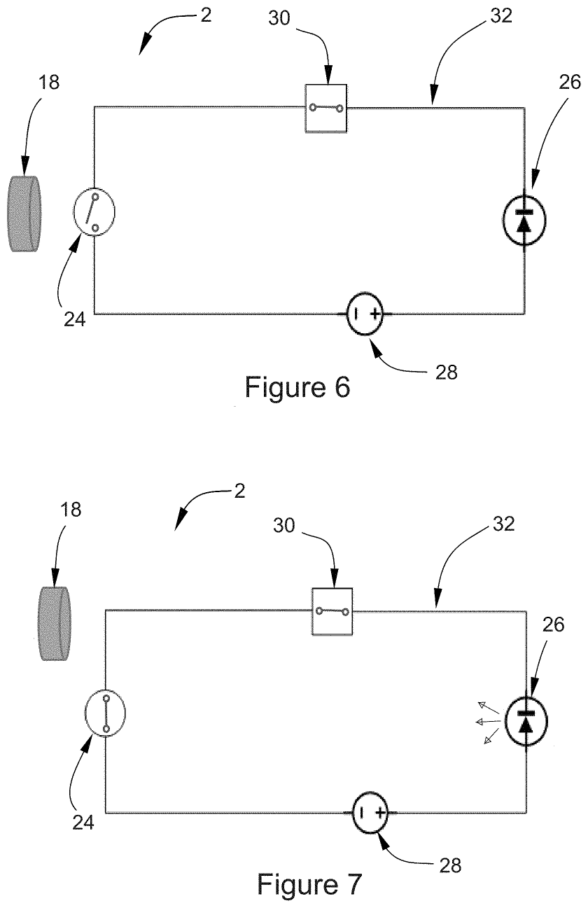

Example circuit diagrams for the first example bite indicator alert device 2 are provided in FIGS. 6 and 7 to better describe alternative constructions and configurations of the bite indicator alert device 2. For instance, FIG. 6 provides a first simplified circuit or wiring diagram for a device 2, such as that which is depicted in FIGS. 1-5. The diagram includes the electrically connected trigger switch 24, at least one light source 26, at least one power source 28, on/off switch 30, and wiring 32. It will be appreciated that in all of the examples within this disclosure, the trigger switch 24 is located in a path of movement of the movement indicator actuator 18. In this example, the trigger switch 24 represents a reed switch that is normally closed, and the on/off switch represents a simple push button switch, although it will be appreciated that alternative on/off switch configurations, such as a toggle switch or other configuration may be used.

The movement indicator actuator 18 in this example is a magnet. In FIG. 6, due to the proximity of the indicator actuator 18 to the trigger switch 24, the normally closed reed switch is in the “open” position, and as a result, no light is being emitted from the at least one light source 26. This corresponds with an inactivated state of the bite indicator alert device 2 and reel 8, which corresponds to a ready position in which a length of fishing line 10 extends from the reel 8, the reel 8 is stationary, and the trigger switch 24 is in a position that does not enable the power source 28 to provide power to the at least one light source 26. The on/off switch 30 is in the “on” position. The “on” position is used when a fisherman is ready to use the device 2 in order to monitor a reel 8 for fish bite activity.

When a fish pulls the fishing line 10, causing the reel 8 to at least partially rotate, the movement indicator actuator 18 on the outer surface 20 of the side wall 22 of the reel 8 is moved away from trigger switch 24, the normally closed reed switch will change from an “open” state, as depicted in FIG. 6, to a “closed” state, as depicted in FIG. 7, which will complete the circuit and turn light source 26 “on.” This is considered an activated state, which corresponds to an active position in which the fishing line 10 has been pulled to a further length extending from the reel 8, subjecting the reel 8 to at least partial rotation via the unwinding of the fishing line 10, which causes movement of the movement indicator actuator 18, and the trigger switch 24 is moved to a position that enables the power source 28 to provide power to the light source 26.

In the simplified circuit diagrams, general symbols are used to represent each of the components of the depicted circuit. However, it should be noted that the symbols used are not intended to limit the potential components. For example, with respect to the light source 26 a number of various light sources may be selected, and indeed are contemplated. For instance, the at least one light source 26 may be at least one LED, or at least one incandescent bulb, or a combination of at least one LED and at least one incandescent bulb. Of course, other light sources also may be used and are contemplated, as will be appreciated by one of ordinary skill in the art, without departing from the teaching or spirit of this disclosure.

The example circuit diagram depicted in FIG. 7 is the same as that depicted in FIG. 6, but showing the device 2 in the activated state. In FIG. 7, a fish has pulled the fishing line 10, causing at least partial rotation of the reel 8, such that the movement indicator actuator 18 is no longer in close proximity with the trigger switch 24. As a result, the normally closed reed switch that had been held “open” due to the close proximity of the indicator actuator 18 has returned to its normally “closed” state, which completes the circuit and turns light source 26 “on.” This corresponds with an activated bite indicator alert device 2 and reel 8, and the device 2 emits light to assist a fisherman by permitting her to identify the activated reel 8, see her surroundings, and attend to the proper fishing line. Other embodiments of the bite indicator alert device 2 are contemplated that can use, for example, a normally closed reed switch or a solid state magnetic switch, but it will be appreciated that all of the embodiments have a read, inactivated state and an activated state associated with at least partial rotation of the reel 8.

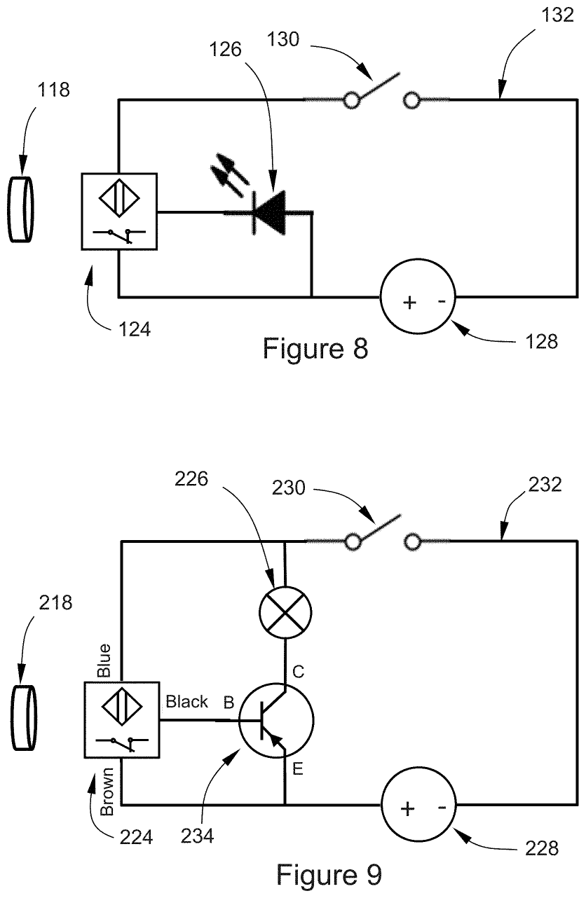

A second example circuit diagram for use with a device similar to that shown in FIGS. 1-5 is depicted in FIG. 8, which includes a trigger switch 124, at least one light source 126, at least one power source 128, an on/off switch 130, and wiring 132. In this example, the trigger switch 124 represents a three wire negative-positive-negative (NPN) inductive proximity sensor that is normally closed. The movement indicator actuator 118 in this embodiment is a metallic object. It will be appreciated that an NPN inductive proximity sensor also is known as a current sinking or negative switching inductive proximity sensor. Due to the close proximity of movement indicator actuator 118 to trigger switch 124, the normally closed inductive proximity sensor is “open” which prevents current flow to the at least one light source 126. As a result, no light is being emitted from light source 126. This corresponds with a ready, inactivated state of the bite indicator alert device 2 and reel 8. The on/off switch 130 is depicted in the “off” position, however, one skilled in the art will understand that it can be switched to the “on” position when a fisherman is ready to use the device 2 in order to monitor a reel 8 for activity. When the fishing line 10 is pulled by a fish, causing at least partial rotation of the reel 8, the movement indicator actuator 118 is moved away from the trigger switch 124, the normally closed inductive proximity sensor will change from an “open” state to a “closed” activated state, which will turn light source 126 “on.”

As the function of the on/off switch has already been described in reference to the previous Figures, no further explanation of its function in the context of other example embodiments is required to enable one skilled in the art to understand this disclosure and make and use the bite indicator alert device. Similarly, as the effect of movement indicator actuator, both in close proximity to, and its remoteness from, trigger switch has already been explained in reference to previous Figures, no further explanation of its function in the context of other example embodiments is required to enable one skilled in the art to understand this disclosure and make and use the device. By reading and following this disclosure, and with specific reference to Figures, one skilled in the art can understand how to make and use a bite indicator alert device where trigger switch is, for example: a reed switch; a normally open three wire NPN inductive proximity sensor; a positive-negative-positive (PNP) three wire inductive proximity sensor; a two wire inductive proximity sensor; a four wire inductive proximity sensor; a two wire AC inductive proximity sensor; or a hall effect sensor.

A third example circuit diagram for use with a device similar to that shown in FIGS. 1-5 is depicted in FIG. 9, which includes a trigger switch 224, at least one light source 226, at least one power source 228, an on/off switch 230, and wiring 232. In this example, the trigger switch 224 represents a three wire NPN inductive proximity switch that is biased to be normally closed. The movement indicator actuator 218 in this embodiment is a metallic object. A PNP transistor 234 also is included. Due to the close proximity of movement indicator actuator 218 to triggered switch2 24, the normally closed inductive proximity switch is “open” which prevents current flow from the base of transistor 234 (indicated with a “B”) to the output of the inductive proximity switch (the output terminal/wire is typically colored black, as indicated in FIG. 9). This prevents current flow from the emitter of transistor 234 (indicated with an “E”) to the collector of transistor 234 (indicated with a “C”), which prevents current from flowing through the light source 226. As a result, no light is being emitted from the light source 226. This corresponds with a ready, inactivated state of the bite indicator alert device 2 and reel 8. When the fishing line is pulled by a fish, causing at least partial rotation of the reel 8, such that the movement indicator actuator 218 is moved away from trigger switch 224, the normally closed inductive proximity switch will change from an “open” state to a “closed” activated state, which will turn the at least one light source 226 “on.”

As is familiar to one skilled in the art, one or more resistors may be required in order achieve and/or to maintain the required values of voltage and current in the circuits that are depicted in this disclosure. The specific need for, and values of, required resistors will depend on the particular choice of components selected for use and their respective electrical values. For example, as one skilled in the art will recognize, the base of a transistor is quite vulnerable to high currents. As a result, a resistor is typically used in order to limit the applied current, thus providing a safe biasing voltage. The required ohm value of the base resistor may be calculated with reference to the source voltage, collector load, transistor gain and the minimum transistor biasing voltage.

Likewise, LEDs are sensitive to high currents. Typically, a resistor is placed in series with one or more LEDs in order to regulate the proper flow of current through each LED. The required value of a resistor placed in series with one or more LEDs may be calculated with reference to the voltage, the number of LED(s) that are placed in series, the forward voltage of the LED(s) used, and the current through the LED(s).

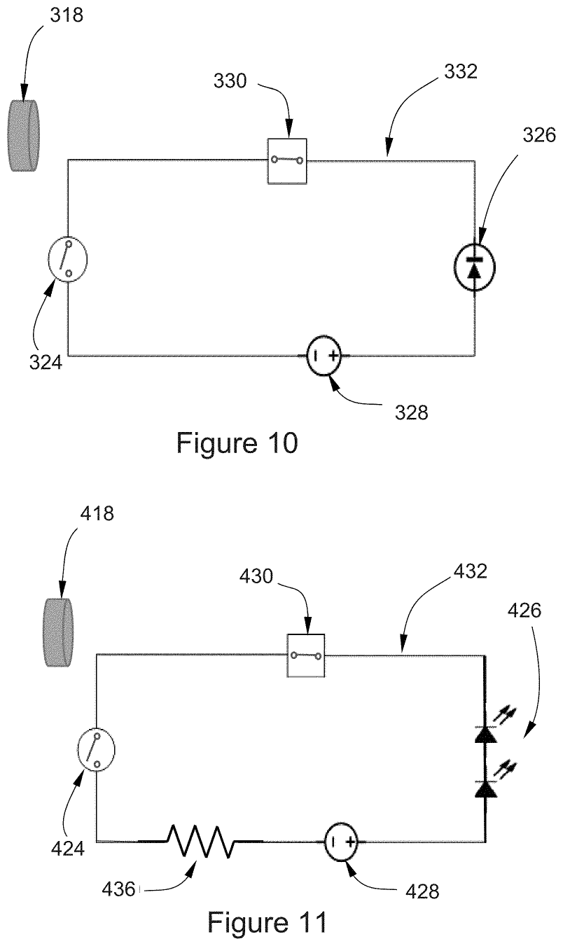

A fourth example circuit diagram for use with a device similar to that shown in FIGS. 1-5 is depicted in FIG. 10, which includes a trigger switch 324, at least one light source 326, at least one power source 328, an on/off switch 330, and wiring 332. In this example, the trigger switch 324 represents a latching (or bi-stable) reed switch that is biased to be normally open. The movement indicator actuator 318 in this embodiment is a magnet. Due to the distance between the movement indicator actuator 318 and the trigger switch 324, the latching reed switch is in the “open” position, and as a result, no light is being emitted from light source 326. This corresponds with a ready, inactivated state of the bite indicator alert device 2 and reel 8. Once the fishing line 10 is pulled by a fish, causing at least partial rotation of the reel 8 and the indicator actuator 318 is moved close enough to actuate trigger switch 324, the normally open latching reed switch will change from an “open” state to a closed” state, which will turn light source 326 “on.” This corresponds with an activated state of the bite indicator alert device 2 and reel 8. As trigger switch 324 is a latching reed switch in this example, trigger switch 324 remains in the “closed” state even after movement indicator actuator 318 is moved away from trigger switch 324. Thus, in this embodiment, once trigger switch 324 has been actuated, such that light source 326 has been turned “on”, light source 326 will remain on until either the on/off switch 30 is turned “off” or the latching reed switch is reset. A latching reed switch can be reset by placing the appropriate pole of a magnet in close proximity to the switch. Once the latching reed switch has been reset, the device 2 is then ready for a fisherman to again use the device in order to monitor a reel 8 for activity.

A fifth example circuit diagram for use with a device similar to that shown in FIGS. 1-5 is depicted in FIG. 11, which includes a trigger switch 424, at least one light source 426 (shown as two LEDs), at least one power source 428, an on/off switch 430, wiring 432 and a resistor 436. In this example, several magnets may be employed for the movement indicator actuator 418, but only one is shown, for convenience. In this example, the trigger switch 424 represents a reed switch that is biased to be normally open. Due to the distance between movement indicator actuator 418 and trigger switch 424, the normally open reed switch is in the “open” position, and as a result, no light is being emitted from light source 426. This corresponds with a ready, inactivated state of the device 2 and reel 8. Once the fishing line 10 is pulled by a fish, causing at least partial rotation of the reel 8 and the movement indicator actuator 418 is moved close enough to actuate trigger switch 424, the normally open reed switch will change from an “open” state to a “closed” state, which will turn light source 426 “on.” This corresponds with an activated state of the bite indicator alert device 2 and reel 8. As more than one magnet may be used for movement indicator actuator 418, trigger switch 424 may remain in the “closed” state when any one of the several magnets is in close proximity with trigger switch 424.

In the example shown and described in reference to FIG. 11, the at least one light source 426 is comprised of two sets of LED lights; a first set of LED lights which may include mainly white light emitting diodes (“white LEDs”); and a second set which may include diodes which emit a substantially uniform non-white color (“colored LEDs”). For example, a set of colored LEDs may emit a substantially uniform red, or dark blue, or green, or fuchsia or a chartreuse colored light. In order to achieve a substantially uniform colored light, the colored LEDs may include, for example, a combination of both yellow and green LEDs, in a ratio of four yellow LEDs to one green LED, so that the substantially uniform colored light is chartreuse.

It will be appreciated that other alternatives for the at least one light source are possible, such as the colored LEDs may include a majority of red LEDs (i.e. LEDs that emit red light) and in another embodiment, the colored LEDs may include both yellow and red LEDs (in about equal numbers of red to yellow LEDs), so that the overall emitted light is perceived to be orange. Optionally, the colored LEDs may be predominantly orange LEDs. In yet another embodiment about two-thirds of the LEDs may be blue and about one-third of the diodes may be red LEDs, so that the overall single emitted light is perceived to be a deep shade of purple.

Of course in other embodiments, the at least one light source may include, for example, at least one LED that is capable of changing colors. While referring to this as an LED, it will be appreciated that such color changing LEDs may include multiple LEDs in an assembly, along with a microcontroller or other means of controlling the color selection. In further alternatives, a colored LED light and an incandescent white light, or a colored incandescent bulb and a gas discharge light that emits white light may be used. Embodiments that include two sets of lights, where one is white and the other of a particular color, may be especially helpful in settings where one or more fisherman simultaneously have multiple lines in the water with an alert device associated with each line. By having a different colored light for each line, the appropriate fisherman may be quickly alerted to which particular line needs attention, while the white light provides enough ambient or task specific light to permit the fisherman to attend to the activated line.

It will be appreciated that in some embodiments, the trigger switch alternatively may be a contact switch, which may include, for example, a micro switch with a roller lever, a micro switch with a hinge lever, a wide contact angle positioning switch that is configured to detect sliding and/or rotating objects, or other suitable contact switches. Such contact switches are optional and not limiting with respect to the types of switches that would be suitable for use. In turn, it will be appreciated that it may be appropriate for a movement indicator actuator to include a mechanical feature, which may be, for example, one or more protruding feature(s), such as a boss or a bump, where the boss or bump may include, for example, filleted interior and/or exterior edges, which may ease the transition of the contacting surface of the switch onto the protruding feature. Alternatively, the movement indicator actuator may include one or more linear bump(s), which may be, for example, generally in the shape of a speed bump. Further, a movement indicator actuator may include one or more recessed feature(s), which may be shaped similar to a protruding feature as previously described herein, but inverted so as to form the shape as a recessed feature. Such mechanical features are examples of the types of mechanical features that may be used and are not intending to be limiting.

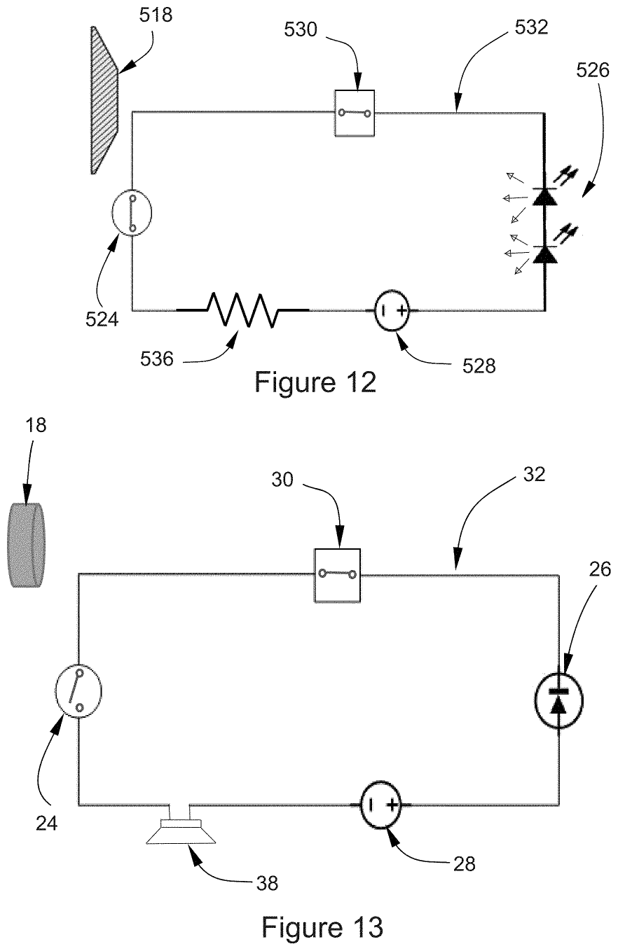

With respect to use of a contact switch, for example, a sixth example circuit diagram for use with a device similar to that shown in FIGS. 1-5 is depicted in FIG. 12, which includes a trigger switch 524, which may be a contact switch, such as a micro switch with a roller lever, and the movement indicator actuator 518 is a mechanical feature, such as a protrusion on the outer surface 20 of a side wall 22 of the reel 8. The circuit also includes at least one light source 526 (in the form of two LEDs), a power source 528, an on/off switch 530, wiring 532 and a resistor 536. With no contact between the movement indicator actuator 518 and the trigger switch 524, the normally closed micro switch would be is in a “closed” position, and as a result, light would be emitted from light source 526. This corresponds with an activated state of the alert device and reel. In order to turn off light source 526, a fisherman may position the movement indicator actuator 518, for example, by rotating the reel 8 to a corresponding position, so that the mechanical feature is in contact with the trigger switch 524, which will actuate the micro switch to turn “off” (that is, to be electrically “open”). Once the movement indicator actuator 518 is in contact with trigger switch 524, the normally closed micro switch will change from a “closed” state to an “open” state, which will turn light source 4 “off.” This corresponds with a ready, inactivated state of the alert device and reel, wherein they are ready to monitor for fish bite activity.

In some embodiments, the trigger switch may be a normally open contact switch with a hinge lever. For example, it may be configured such that when the lever is not in contact with an object, it is electrically open; and when the lever is in contact with an object, the switch is electrically closed. Such a switch may be combined with a movement indicator actuator that is a recessed feature. This combination would permit the trigger switch to be “open” when proximate the recessed feature (that is, the lever portion of the switch is permitted to swing out, as the recessed feature provides sufficient clearance for the lever), and “closed” in all other positions (that is, the lever portion of the switch is forced into the body of the switch, as there is not sufficient clearance to permit the lever to swing out). When the normally open micro switch is proximate with movement the indicator actuator (the recessed feature), the lever portion of the switch is permitted to swing out which places the trigger switch in an electrically “open” state and no light is emitted from light source, corresponding with an inactivated alert device and reel. When the fishing line 10 is pulled and the reel is at least partially rotated, such that the movement indicator actuator (the recessed feature) is no longer proximate the trigger switch, the lever portion of the switch is forced into the body of the switch, which places the trigger switch in an electrically “closed” state and light is emitted from light source, corresponding with an activated state of the alert device and reel.

As noted previously, it will be appreciated that the ice fishing bite indicator alert device may be used with a rattle reel or a reel that does not otherwise generate noise when it rotates. In either instance, the ice fishing bite indicator alert device may additionally feature an electronic sound source, which will provide an audible alert. Thus, at least one sound source may be substituted for the at least one light source, or may be added to the circuit to be activated in combination with the at least one light source. A simplified seventh example circuit diagram is provided in FIG. 13 for use in a device such as the bite indicator alert device 2 shown in FIGS. 1-5, but with the addition of at least one sound source. The seventh example circuit diagram is similar to the first example in FIG. 6, but additionally includes at least one sound source 38, which, for example, in its most simple form may be a horn. In this example, the device would work similarly to the description of FIGS. 6 and 7, but additionally would emit an audible alert sound from the sound source 38, simultaneously with the light being emitted from the at least one light source 26.

As noted, it will be appreciated that the sound source 38 could be as simple as a horn, however, it also will be appreciated that the sound source 38 of the ice fishing bite indicator alert device additionally may provide a switch to deactivate the at least one sound source 38 or a volume control. In still further example embodiments, the at least one sound source 38 may include a preloaded, recordable or customizable sound source, such as may be provided, for example, by use of a sound board or a programmable sound chip module. Such sound source devices in a miniature or relatively small configuration are known, available and may be incorporated into the circuit, so as to provide the ability to play any number of preset, pre-loaded or pre-recorded sound bites. Alternatively, a programmable sound chip module may permit the fisherman to load or record sound bites of the fisherman's choosing, for playback when the ice fishing bite indicator alert device is in an activated state. Such configuration of a sound source 38 also may include an interface, such as may feature buttons for establishing settings on the sound source that will be customized to the preference of the fisherman.

In accordance with above-discussed Figures, an ice fishing bite indicator alert device may be assembled in a variety of ways that would be consistent with the present disclosure. The circuit diagrams indicate the use of wiring that would be used to electrically connect the at least one power source, on/off switch, trigger switch, at least one light source and any transistor and/or resistor and/or sound source, if included in the particular configuration.

In order to use the ice fishing bite indicator alert device while ice fishing, a fisherman can prepare her line with an appropriate selection of a hook, weights, live bait and artificial lures, etc., so that the presentation and other considerations are suitable for the targeted fish species. Once the line has been prepared, the fisherman can lower the line into the water to the desired depth using a supported reel (i.e. a reel that is statically supported above the ice), or a supported rattle reel, if desired.

Next, the fisherman mounts the alert device such that the trigger switch is positioned in a path of movement of the movement indicator actuator and in a position relative to the movement indicator actuator such that the alert device and reel are in a ready, “inactivated” state, as previously described herein. Alternately, the alert device may already be mounted or attached in a manner described herein. If this is the case, then depending on the type of trigger switch being used, the fisherman would rotate the reel in order to position the trigger switch in a position relative to movement indicator actuator, such that the alert device and reel are in a ready, “inactivated” state.

When a fish pulls on the line, some of the line unwinds off of the reel, causing at least partial rotation of the reel and the corresponding movement of the movement indicator actuator away from the trigger switch, resulting in an “active” state of the alert device and the corresponding reel. This activation causes the alert device to emit a light and/or sound. The emitted light and/or sound can greatly assist in waking or otherwise drawing the attention of the fisherman, and help the fisherman to identify the activated reel, see her surroundings, and attend to the proper line. Once the line has been properly attended to, hopefully by securing a fish that has been caught, and if so required or desired, re-preparing the line, then the fisherman may re-lower the line into the water to the desired depth and rotate the reel in order to again position the movement indicator actuator relative to the trigger switch. This will reset the alert device from its “activated” state to its “inactive” state, wherein it again will be ready to detect a biting fish.

From the above disclosure, it will be apparent that ice fishing bite indicator alert devices that are constructed in accordance with this disclosure may include a number of structural aspects that provide numerous advantages. The example aspects of such devices shown herein may exhibit one or more of the above-referenced potential advantages, depending upon the specific design chosen.

It will be appreciated that an ice fishing bite indicator alert device in accordance with the present disclosure may be provided in various configurations. Any variety of suitable materials of construction, configurations, shapes and sizes for the components and methods of connecting the components may be utilized to meet the particular needs and requirements of an end user. It is to be understood that the invention is not to be limited to the examples disclosed herein, but rather, is intended to cover various modifications and equivalent arrangements included within the spirit and scope of the appended claims. Thus, the description and drawings should be considered illustrative and not restrictive of the invention, which is limited only by the appended claims and their legal equivalents.

1. An ice fishing bite indicator alert device for use with a reel having wound fishing line, comprising:
a housing having a mount that locates the housing proximate the fishing reel;
at least one movement indicator actuator located on the reel in a position spaced from an axis of rotation of the reel;
the housing supporting an electrically connected circuit that includes a trigger switch, at least one light source, at least one power source, and an on/off switch;
the trigger switch being located within a path of movement of the at least one movement indicator actuator;
the electrically connected circuit having an inactivated state and an activated state which are associated with the location of the at least one movement indicator actuator relative to the trigger switch;
the inactivated state corresponding to a ready position in which a length of fishing line extends from the reel, the reel is stationary, and the trigger switch is in a position that does not enable the power source to provide power to the light source;
the activated state corresponding to an active position in which the fishing line has been pulled to a further length extending from the reel, the reel is subjected to at least partial rotation causing movement of the at least one movement indicator actuator, resulting in the trigger switch being in a position that enables the power source to provide power to the light source.

2. The ice fishing bite indicator alert device in accordance with claim 1, wherein the at least one light source further comprises at least one LED or incandescent light.

3. The ice fishing bite indicator alert device in accordance with claim 1, wherein the at least one light source provides white light or at least one color of light other than white.

4. The ice fishing bite indicator alert device in accordance with claim 1, wherein the at least one light source provides a plurality of colors of light.

5. The ice fishing bite indicator alert device in accordance with claim 1, wherein the at least one movement indicator actuator further comprises a magnet or a piece of metal.

6. The ice fishing bite indicator alert device in accordance with claim 1, wherein the at least one movement indicator actuator further comprises an elongated strip or a plurality of pieces.

7. The ice fishing bite indicator alert device in accordance with claim 1, wherein the trigger switch further comprise a reed switch.

8. The ice fishing bite indicator alert device in accordance with claim 1, wherein the trigger switch further comprises an NPN or PNP inductive proximity sensor.

9. The ice fishing bite indicator alert device in accordance with claim 1, wherein the trigger switch further comprises a contact switch.

10. The ice fishing bite indicator alert device in accordance with claim 1, wherein the inactivated state corresponds to the trigger switch being in an open position and the activated state corresponds to the trigger switch being in a closed position.

11. The ice fishing bite indicator alert device in accordance with claim 1, wherein the inactivated state corresponds to the trigger switch being in a closed position and the activated state corresponds to the trigger switch being in an open position.

12. The ice fishing bite indicator alert device in accordance with claim 1, further comprising at least one sound source.

13. The ice fishing bite indicator alert device in accordance with claim 12, wherein the at least one sound source further comprises a horn, or a preloaded, recordable or programmable sound module.

14. The ice fishing bite indicator alert device in accordance with claim 1, wherein the reel is a rattle reel.

15. The ice fishing bite indicator alert device in accordance with claim 1, wherein the reel further comprises an axle on which the reel rotates.

16. The ice fishing bite indicator alert device in accordance with claim 15, wherein the mount further comprises at least one magnet connected to the housing and removably connected to the axle.

17. The ice fishing bite indicator alert device in accordance with claim 1, wherein the power source further comprises at least one battery.

18. The ice fishing bite indicator alert device in accordance with claim 1, wherein the at least one battery is rechargeable.

19. The ice fishing bite indicator alert device in accordance with claim 1, further comprising a transistor.

20. The ice fishing bite indicator alert device in accordance with claim 1, further comprising a resistor.
